(19) United States
(12) Patent Application Publication
(10) Pub. No.: US 2021/0285366 A1
(43) Pub. Date: Sep. 16, 2021

(54) SUPERCHARGING PRESSURE CONTROL DEVICE FOR INTERNAL COMBUSTION ENGINE

(71) Applicant: Honda Motor Co., Ltd., Tokyo (JP)

(72) Inventors: Jyo ISHIMASA, Saitama (JP); Masaki UENO, Saitama (JP)

(73) Assignee: Honda Motor Co., Ltd., Tokyo (JP)

(21) Appl. No.: 17/195,540

(22) Filed: Mar. 8, 2021

(30) Foreign Application Priority Data
Mar. 12, 2020 (JP) 2020-042650

(51) Int. Cl. F02B 37/24; F02D 23/00

(52) U.S. Cl. CPC F02B 37/24; F02D 2200/101; F02D 23/00

(57) ABSTRACT

The disclosure provides a supercharging pressure control device of an internal combustion engine capable of effectively suppressing a failure of a device such as an internal combustion engine or a supercharger when a variable nozzle is stuck. A supercharging pressure control device of an internal combustion engine according to the disclosure includes: a supercharger (turbocharger) which is provided in the internal combustion engine (engine) and controls a supercharging pressure by changing an opening degree of a variable nozzle; a rotation speed acquisition part (rotation speed sensor) which acquires a rotation speed (engine rotation speed) of the internal combustion engine; and an opening degree limiting part (ECU) which limits the opening degree of the variable nozzle based on the rotation speed when the acquired rotation speed exceeds a predetermined value.

### CROSS-REFERENCE TO RELATED APPLICATION

This application claims the priority benefit of Japan application serial no. 2020-042650, filed on Mar. 12, 2020. The entirety of the above-mentioned patent application is hereby incorporated by reference herein and made a part of this specification.

### TECHNICAL FIELD

The disclosure relates to a supercharging pressure control device of an internal combustion engine, and more particularly to a supercharging pressure control device using a supercharger having a variable nozzle for changing the supercharging pressure.

### DESCRIPTION OF RELATED ART

Conventionally, various measures have been proposed to control the supercharging pressure of the intake air of the internal combustion engine to an appropriate value according to the operating state. For example, in the control method of a variable-capacity supercharger described in Patent Document 1, after the basic supercharging pressure control amount is set in advance according to the engine rotation speed and the throttle opening degree, the region where the basic supercharging pressure control amount decreases is defined among the region determined by the engine rotation speed and the supercharging pressure. In this way, control is performed to decrease the supercharging pressure when an overload occurs at the time of a sudden start, and an overload on the automatic transmission is prevented, and overshoot and hunting are prevented from occurring.

[Patent Document 1] Japanese Laid-open No. H01-285622

In a variable-capacity supercharger which controls the supercharging pressure by changing the flow rate of the exhaust gas toward the turbine wheel by changing the exhaust flow path area with a variable nozzle, one issue is the sticking of the variable nozzle (nozzle vane) which may occur when the supercharger operates. That is, in a variable-capacity supercharger, the opening degree of the variable nozzle is controlled to the closed side and the opening area is decreased to increase the flow rate of the exhaust gas, thereby obtaining a large supercharging pressure. However, if sticking occurs while the variable nozzle is controlled to the closed side, the supercharging pressure and the exhaust pressure (exhaust pressure on the upstream side of the turbine wheel) increase excessively, which increases the possibility of failures of devices such as the internal combustion engine and the supercharger.

In the technique of Patent Document 1, the control to decrease the supercharging pressure is performed when the supercharging pressure is high in the region where the engine rotation speed is low, while when the supercharging pressure is low in the region where the engine rotation speed is high, the control to decrease the supercharging pressure is not performed. However, under actual operating conditions, in the region where the engine rotation speed is low, even if the supercharging pressure keeps increasing, since the increase in the exhaust pressure is relatively gradual, it is not likely that the device will fail due to the increase in the exhaust pressure even if the variable nozzle is stuck. On the other hand, in the region where the engine rotation speed is high, since the increasing speed of the exhaust pressure may be greater than the increasing speed of the supercharging pressure, the device may fail due to the increase in the exhaust pressure. Therefore, it is difficult for the technique of Patent Document 1 to appropriately deal with such a problem.

### SUMMARY

In order to achieve the above, a supercharging pressure control device of an internal combustion engine according to a first aspect of the disclosure includes: a supercharger (supercharger 12) which is provided in the internal combustion engine (engine 1 in the embodiment, and the same applies hereinafter) and controls a supercharging pressure PB by changing an opening degree AVG of a variable nozzle 124; a rotation speed acquisition part (rotation speed sensor 9) which acquires a rotation speed (engine rotation speed NE) of the internal combustion engine; and an opening degree limiting part (ECU 20) which limits the opening degree of the variable nozzle based on the rotation speed when the acquired rotation speed exceeds a predetermined value NETH.

### BRIEF DESCRIPTION OF THE DRAWINGS

FIG. 1 is a diagram schematically showing a configuration of an internal combustion engine.

FIG. 2 is a schematic cross-sectional diagram of a variable nozzle of a variable-capacity supercharger.

FIG. 3 is a block diagram showing a configuration of a control device of an internal combustion engine.

FIG. 4 is a flowchart showing a control process for limiting an opening degree by an opening degree limiting part.

FIG. 5 is a map for setting a limit value of an opening degree of a variable nozzle according to the rotation speed of an internal combustion engine.

### DESCRIPTION OF THE EMBODIMENTS

The disclosure has been made to solve this problem and provides a supercharging pressure control device of an internal combustion engine capable of effectively suppressing failures of devices when the variable nozzle is stuck.

In order to achieve the above, a supercharging pressure control device of an internal combustion engine according to a first aspect of the disclosure includes: a supercharger (supercharger 12) which is provided in the internal combustion engine (engine 1 in the embodiment, and the same applies hereinafter) and controls a supercharging pressure PB by changing an opening degree AVG of a variable nozzle 124; a rotation speed acquisition part (rotation speed sensor 9) which acquires a rotation speed (engine rotation speed NE) of the internal combustion engine; and an opening degree limiting part (ECU 20) which limits the opening degree of the variable nozzle based on the rotation speed when the acquired rotation speed exceeds a predetermined value NETH.

As described above, when the rotation speed of the internal combustion engine is low, the exhaust pressure does not become excessively large even if the nozzle opening degree is brought close to full closure to increase the flow rate to increase the supercharging pressure. Therefore, even if the variable nozzle is stuck at an opening degree close to full closure, it is unlikely that the internal combustion engine or the supercharger will fail due to an increase in the exhaust pressure. On the other hand, when the rotation speed of the internal combustion engine is high, if the supercharging efficiency when the opening degree of the variable nozzle is controlled to the closed side deteriorates, the increasing speed of the exhaust pressure may be greater than the increasing speed of the supercharging pressure; if the variable nozzle is stuck, it is very likely that the internal combustion engine or the supercharger will fail due to the increase in the exhaust pressure. Therefore, according to the supercharging pressure control device of the internal combustion engine according to the disclosure, by limiting the opening degree of the variable nozzle when the rotation speed of the internal combustion engine exceeds a predetermined value regardless of the supercharging pressure, it is possible to effectively suppress the failure of the internal combustion engine or the supercharger due to the increase in the exhaust pressure even if the variable nozzle is stuck. Further, since the opening degree of the variable nozzle is limited according to the rotation speed of the internal combustion engine, it is possible to more effectively suppress the failure of the internal combustion engine or the supercharger due to the increase in the exhaust pressure.

According to a second aspect of the disclosure, in the supercharging pressure control device of the internal combustion engine according to the first aspect, the opening degree limiting part limits the opening degree of the variable nozzle more as the rotation speed increases.

According to this configuration, the higher the rotation speed of the internal combustion engine is, the greater the limitation on the opening degree of the variable nozzle is. Therefore, the nozzle opening degree may be further limited in the region where the increasing speed of the exhaust pressure becomes higher, and it is possible to more effectively suppress the failure of the internal combustion engine or the supercharger due to the increase in the exhaust pressure.

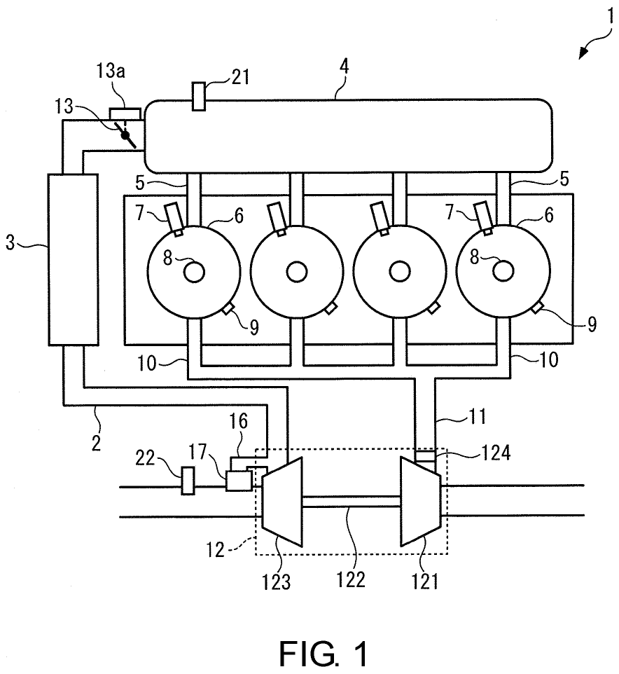

Hereinafter, exemplary embodiments of the disclosure will be described in detail with reference to the drawings. As shown in FIG. 1, an internal combustion engine (hereinafter referred to as the engine) 1 is mounted on a vehicle, has, for example, four cylinders 6 in series, and is a direct injection engine which directly injects fuel into combustion chambers (not shown) of the cylinders 6. Each cylinder 6 is provided with a fuel injection valve 7, a spark plug 8, an intake valve and an exhaust valve (neither of which is shown). Further, a crankshaft which converts the reciprocating motion of a piston in the combustion chamber into rotational motion (none of which is shown) is provided with a rotation speed sensor 9 which detects the rotation speed of the engine 1 (engine rotation speed NE).

Further, the engine 1 includes an intake path 2, an exhaust path 11, and a turbocharger 12 as a supercharger. The intake path 2 is connected to a surge tank 4, and the surge tank 4 is connected to the combustion chamber of each cylinder 6 via an intake manifold 5. The intake path 2 is provided with a compressor 123 (to be described later) of the turbocharger 12, an intercooler 3 for cooling the air pressurized by the turbocharger 12, and a throttle valve 13 from the upstream side in this order. The throttle valve 13 is driven by a throttle (TH) actuator 13a. The surge tank 4 is provided with a supercharging pressure sensor 21 which detects the supercharging pressure PB, and the intake path 2 is provided with an intake air flow rate sensor 22 which detects the intake air flow rate GAIR.

The turbocharger 12 includes a turbine 121 provided in the exhaust path 11 and rotationally driven by the kinetic energy of the exhaust gas, and includes the compressor 123 provided in the intake path 2 and connected to the turbine 121 via a shaft 122. The compressor 123 pressurizes the air (intake gas) taken into the engine 1 and supercharges it. A bypass path 16 which bypasses the compressor 123 is connected to the intake path 2, and the bypass path 16 is provided with an air bypass valve (AB valve) 17 for adjusting the flow rate of air passing through the bypass path 16.

The exhaust path 11 is connected to the combustion chamber of each cylinder 6 via an exhaust manifold 10. The exhaust path 11 is connected to a variable nozzle 124 provided in the turbine 121, and as to be described later, the variable nozzle 124 adjusts the flow rate of air (exhaust gas) passing through the variable nozzle 124 by changing the flow path area, thereby changing the supercharging efficiency.

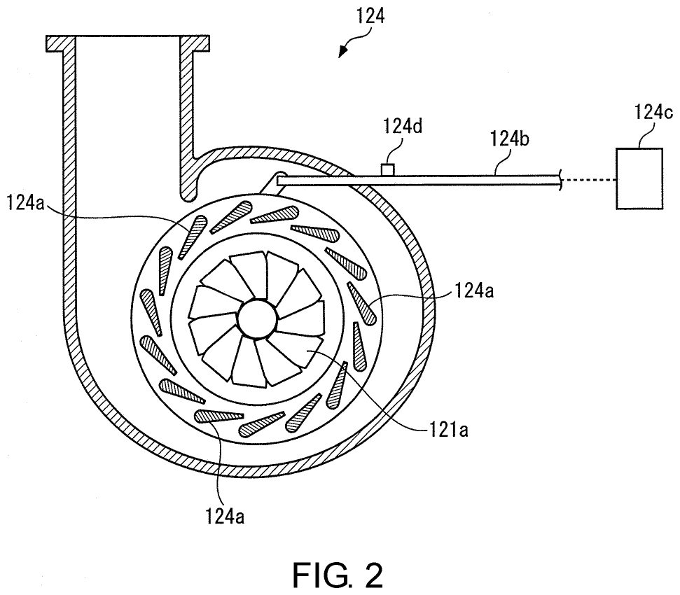

FIG. 2 is a cross-sectional diagram schematically showing the variable nozzle 124. The variable nozzle 124 includes multiple nozzle vanes 124a which are provided in a housing of the turbine 121 and whose angles are changeable. Each nozzle vane 124a is connected to a vane actuator 124c via a rod 124b, and when the rod is driven by the vane actuator 124c, the angle of each nozzle vane 124a is changed accordingly. Further, the rod 124b is provided with a variable nozzle opening degree sensor 124d which detects the angle of the nozzle vane 124a as the opening degree of the variable nozzle (variable nozzle opening degree AVG).

In the disclosure, the variable nozzle opening degree AVG means the angles of the nozzle vanes 124a, and when it is described that the variable nozzle opening degree AVG is decreased or controlled to the closed side, it means that all the nozzle vanes 124a are driven in a direction in which the distance between two adjacent nozzle vanes 124a is narrowed. Further, when it is described that the variable nozzle opening degree AVG is increased or controlled to the open side, it means that all the nozzle vanes 124a are driven in a direction in which the distance between two adjacent nozzle vanes 124a is widened. Further, for example, AVG=0% means the minimum opening degree that may be controlled during the operation of the engine 1, and AVG=100% means the maximum opening degree that may be controlled during the operation of the engine 1.

Based on the above definition, when the variable nozzle opening degree AVG is decreased, the distance between the nozzle vanes 124a is narrowed, whereby the flow path area of the exhaust gas toward a turbine wheel 121a is decreased. In this way, the flow rate of the exhaust gas passing through the variable nozzle 124 increases, and the rotation speed of the turbine wheel 121a increases, whereby the rotation speed of the compressor 123 integrally connected to the turbine 121 increases, and the supercharging pressure PB increases. On the contrary, when the variable nozzle opening degree AVG is increased, the distance between the nozzle vanes 124a is widened, whereby the flow path area is widened, and the flow rate of the passing exhaust gas decreases, so the rotation speeds of the turbine wheel 121a and the compressor 123 decrease, and the supercharging pressure PB decreases.

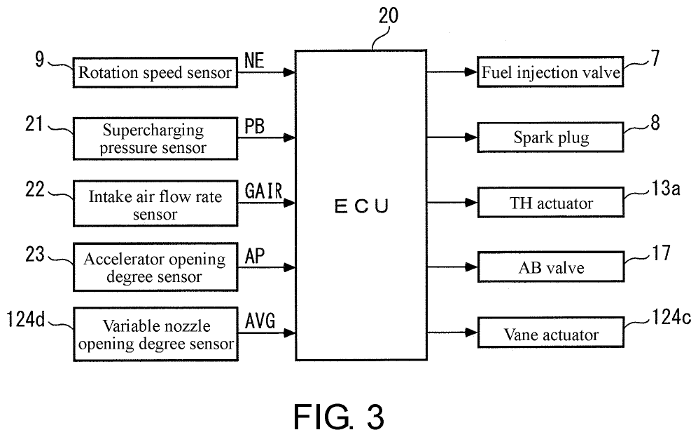

FIG. 3 shows a configuration of a control device of the engine 1. An electronic control unit (hereinafter referred to as the ECU) 20 is configured by a microcomputer including a CPU, a RAM, a ROM, an I/O interface (none of which is shown), and the like. In addition to the supercharging pressure sensor 21, the intake air flow rate sensor 22, the variable nozzle opening degree sensor 124d and the rotation speed sensor 9 described above, an accelerator opening degree sensor 23 which detects the operation amount (accelerator opening degree AP) of the accelerator pedal of the vehicle and the like are also connected to the ECU 20, and detection signals thereof are sequentially input to the ECU 20. The fuel injection valve 7, the spark plug 8, the TH actuator 13a, the vane actuator 124c, the AB valve 17 and the like are connected to the output side of the ECU 20.

The ECU 20 controls the engine 1 according to the detection signals of the various sensors described above and the like. Specifically, in the embodiment, the ECU 20 controls the supercharging pressure PB by changing the opening degree AVG of the variable nozzle 124 according to the operating state of the engine 1 (mainly the engine rotation speed NE and the accelerator opening degree AP).

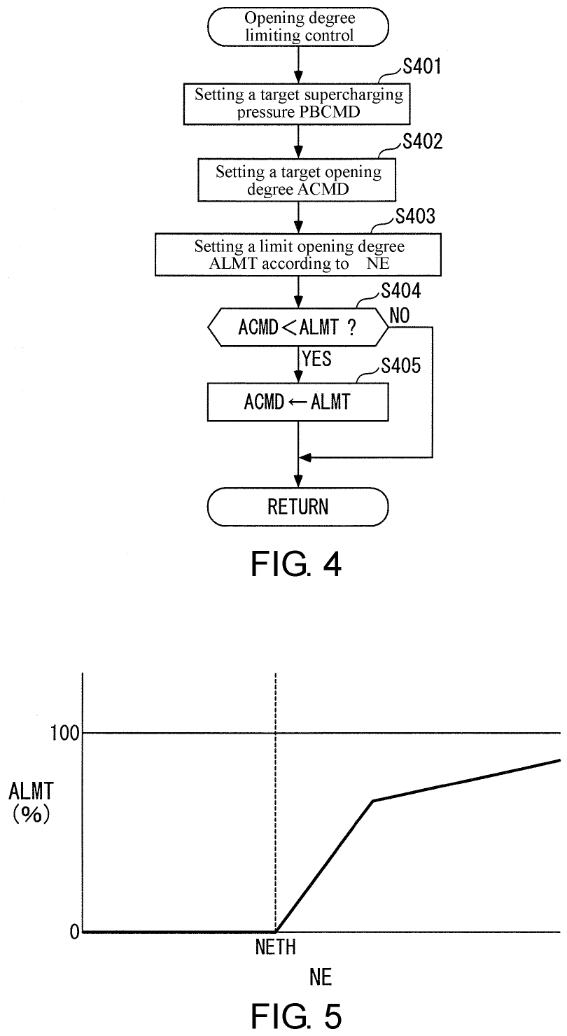

Hereinafter, the supercharging pressure control in the embodiment will be described with reference to FIGS. 4 and 5. FIG. 4 is a flowchart showing a control process for limiting the opening degree of the variable nozzle 124. This process is repeatedly executed in the ECU 20 at predetermined time intervals.

In this process, first, step 401 (shown as “S401,” and the same applies hereinafter), a target supercharging pressure PBCMD is set based on the engine rotation speed NE, the intake air flow rate GAIR, the accelerator opening degree AP, and the like. Next, in step 402, a target opening degree ACMD of the variable nozzle 124 is set based on the supercharging pressure PB and the target supercharging pressure PBCMD. The target opening degree ACMD is a variable nozzle opening degree for quickly increasing the supercharging pressure PB to the target supercharging pressure PBCMD.

Next, in step 403, a limit opening degree ALMT is set by searching the map shown in FIG. 5 according to the engine rotation speed NE. As to be described later, the limit opening degree ALMT is used as the lower limit value of the variable nozzle opening degree AVG. In this map, when the engine rotation speed NE is less than or equal to a predetermined value NETH, the limit opening degree ALMT is set to 0; that is, the variable nozzle opening degree AVG is not limited. Further, when the engine rotation speed NE exceeds the predetermined value NETH, the limit opening degree ALMT is set to a greater value as the engine rotation speed NE increases, that is, to pose more limitation on the opening degree on the closed side of the variable nozzle 124.

Next, in step 404, it is determined whether the target opening degree ACMD is less than the limit opening degree ALMT. If the result of the determination is YES, that is, if the target opening degree ACMD is less than the limit opening degree ALMT, in step 405, the target opening degree ACMD is limited by being set to the limit opening degree ALMT, and this process ends. If the result of the determination in step 404 is NO and the target opening degree ACMD is greater than or equal to the limit opening degree ALMT, this process ends without changing the target opening degree ACMD.

As described above, according to the embodiment, regardless of the supercharging pressure, when the engine rotation speed NE exceeds the predetermined value NETH, the limit opening degree ALMT is set in the target opening degree ACMD, whereby the variable nozzle opening degree AVG is controlled so as not to be closer to the closed side than the limit opening degree ALMT. In this way, even when the variable nozzle 124 is stuck, it is possible to effectively suppress the occurrence of the failure of the engine 1 or the turbocharger 12 due to an excessive increase in the exhaust pressure.

Further, the higher the engine rotation speed NE is, the larger the limit opening degree ALMT is set. Therefore, the variable nozzle opening degree AVG may be further limited in the region where the increasing speed of the exhaust pressure becomes higher, and it is possible to more effectively suppress the occurrence of the failure of the engine 1 or the turbocharger 12 due to an excessive increase in the exhaust pressure.

Further, the disclosure is not limited to the above-described embodiment, and may be implemented in various embodiments. For example, in the embodiment, the map of FIG. 5 is used to set the limit opening degree of the variable nozzle according to the rotation speed of the internal combustion engine, but the map is merely an example and may be changed as appropriate. In addition, it is possible to appropriately change the detailed configuration within the scope of the spirit of the disclosure.

What is claimed is:

1. A supercharging pressure control device of an internal combustion engine, comprising:
a supercharger which is provided in the internal combustion engine and is configured to control a supercharging pressure by changing an opening degree of a variable nozzle;
a rotation speed acquisition part which is configured to acquire a rotation speed of the internal combustion engine; and
an opening degree limiting part which is configured to limit the opening degree of the variable nozzle based on the rotation speed when the acquired rotation speed exceeds a predetermined value.

2. The supercharging pressure control device of the internal combustion engine according to claim 1, wherein
the opening degree limiting part is configured to limit the opening degree of the variable nozzle more as the rotation speed increases.
